(19) United States
(12) Patent Application Publication
(10) Pub. No.: US 2007/0083891 A1
(43) Pub. Date: Apr. 12, 2007

(54) Image processing apparatus and control method thereof

(75) Inventor: Byung-Hoon Moon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/518,261

(22) Filed: Sep. 11, 2006

(30) Foreign Application Priority Data
Oct. 6, 2005 (KR) 10-2005-0093892

(51) Int. Cl. H04N 5/445; G06F 13/00; H04N 7/173; G06F 3/00; H04N 7/16

(52) U.S. Cl. 725/39; 725/134; 725/142; 725/100; 725/41

(57) ABSTRACT

An image processing apparatus and a control method of controlling the image processing apparatus are provided. The control method of the image processing apparatus, which includes a display unit indicating images according to received broadcast signals, includes: storing data of a broadcast signal, and if individual day broadcast information is requested, displaying the individual day broadcast information corresponding to a broadcast channel for a plurality of days based on the stored data on a portion of the display unit. Accordingly, the broadcast information concerning the plurality of individual days is provided to enable viewers to simply and rapidly grasp individual day broadcast programs.

### CROSS-REFERENCE TO RELATED APPLICATIONS

This application claims priority from Korean Patent Application No. 10-2005-0093892, filed on Oct. 6, 2005, in the Korean Intellectual Property Office, the disclosure of which is incorporated herein by reference.

### BACKGROUND OF THE INVENTION

1. Field of the Invention

The present invention relates to controlling an image processing apparatus, and more particularly, to an image processing apparatus and a method of controlling the same, which provide broadcast information according to a plurality of individual days, and thus provides a broadcast information guide to enable viewers to simply and rapidly learn the individual day broadcast programs.

2. Description of the Related Art

A general image processing apparatus includes a signal processor which processes received broadcast signals and a display unit which displays a broadcast image according to the broadcast signal processed in the signal processor.

As digital broadcast services are being increasingly provided, digital televisions which receive and display digital broadcast signals are being increasingly distributed. Thus, most homes can easily access digital broadcasts. One of the features of the digital broadcasts is to provide abundant information on broadcast channels and broadcast programs.

Thus, an image processing apparatus (hereinafter referred to as a digital television) receives a conventional digital broadcast and processes received information. The digital television receives an Electronic Program Guide (EPG) including various information such as broadcast channel information and broadcast program information. In the case that broadcast information is requested by a user, the digital television displays a broadcast information guide based on the EPG information, that is, an EPG screen on a display unit in order to provide a user with the broadcast information.

FIG. 1 is a view of an EPG screen 1 providing a user with broadcast information based on a request of a user (for example, an input of an EPG information key) in a conventional digital television. As shown in FIG. 1, the conventional EPG screen 1 includes hourly broadcast program information 1b of each broadcast channel, which uses a horizontal axis as a broadcast time and a longitudinal axis as a broadcast channel; a picture screen 1a displaying an image corresponding to the broadcast program indicated in the hourly broadcast program information 1b of each broadcast channel; and a detailed information indicator 1c indicating the detailed information of the indicated broadcast program.

As described above, the conventional image processing apparatus displays an EPG screen 1 considering various kinds of broadcast program information corresponding to broadcast programs to be broadcasted for a predetermined time which are provided from a predetermined number of broadcast channels at a current time. Thus, the conventional image processing apparatus displays only a small number of broadcast programs on a restricted position of the EPG screen 1 since there are many kinds of information (a broadcast time, a broadcast genre, etc.) to be displayed on the EPG screen 1 in order to indicate hourly broadcast information of each broadcast channel. Thus, in the case of the conventional image processing apparatus, viewers have the difficulty of grasping what broadcast programs are broadcasted for a day at a glance, and have the difficulty of grasping information on what broadcast programs are to be broadcasted on each individual day.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image processing apparatus and a method of controlling the same, which provides a broadcast information guide which provide individual day broadcast information according to a plurality of days to thereby enable viewers to simply and rapidly grasp individual day broadcast programs, and provides simple channel individual broadcast information according to a plurality of channels corresponding to a current day to thereby enable viewers to simply and rapidly grasp the channel broadcast programs.

According to an aspect of the present invention, there is provided a control method of an image processing apparatus having a display unit displaying images based on received broadcast signals, the control method comprising: storing additional data received through a predetermined broadcast signal; determining whether individual day broadcast information is requested; and displaying the individual day broadcast information according to a plurality of days corresponding to a predetermined broadcast channel based on the stored additional data on a portion of the display unit when the individual day broadcast information has been requested.

The individual day broadcast information according to the plurality of days may comprise broadcast program title information among the individual day broadcast program information according to the plurality of days corresponding to the predetermined broadcast channel.

The displaying the individual day broadcast information according to the plurality of days may comprise enumerating and displaying the individual day broadcast program title information of the plurality of days corresponding to the predetermined broadcast channel according to a broadcast time table of each day when the individual day broadcast information is requested.

The displaying the individual day broadcast information may comprise displaying the individual day broadcast information of the plurality of days corresponding to a broadcast channel to be reproduced when the individual day broadcast information is requested.

The displaying the individual day broadcast information of the plurality of days may comprise displaying a weekly broadcast information guide including the individual day broadcast information of one week corresponding to the broadcast channel.

The displaying the weekly broadcast information guide may further comprise displaying a channel identifier item showing a broadcast channel corresponding to the individual day broadcast information for the indicated one week on the weekly broadcast information guide.

The displaying the weekly broadcast information guide may comprise displaying the weekly broadcast information guide in the state of indicating the channel identifier item by using a predetermined indication highlight, if the individual day broadcast information is requested.

The control method may further comprise: determining whether a left/right shift for converting the channel identifier is input from the outside in the state where the channel identifier item is indicated; and converting the current broadcast channel into a broadcast channel of the channel identifier item according to the input left/right shift when the left/right shift is input from the outside.

The control method may further comprise converting the individual day broadcast information for one week displayed on the weekly broadcast information guide into the individual day broadcast information of one week corresponding to the converted broadcast channel in the case that the broadcast channel of the channel identifier item is converted.

The control method may further comprise: determining whether a predetermined choice input is input from the outside in the state where the channel identifier item is directed; and if the choice input is input, further displaying a program indication highlight indicating broadcast information corresponding to a current broadcast time among the individual day broadcast information of the displayed one week.

The control method may further comprise: determining whether the left/right shift is input from the outside in the state where the program indication highlight has been indicated; and making the program indication highlight move to the left/right direction on day items of the individual day broadcast information of the indicated one week according to the input left/right shift when the left/right shift has been input.

The control method may further comprise: determining whether an up/down shift is input from the outside in the state where the program indication highlight has been indicated; and making the program indication highlight move to the up/down direction on broadcast program title items of the individual day broadcast information of the indicated one week according to the input up/down shift when the up/down shift has been input.

The control method may further comprise: determining whether a detailed information request is input from the outside in the state where the channel indication highlight has been indicated; and if the detailed information request has been input, displaying detailed broadcast program information of the broadcast programs directed by the program indication highlight on the individual day broadcast information of the displayed one week, if the detailed information request has been input.

The detailed broadcast program information may comprise in least one of title information, broadcast time information, view age limit information, broadcast genre information, broadcast content information, and character information of the indicated broadcast program.

The displaying the weekly broadcast information guide may comprise further displaying an image screen on a portion of the weekly broadcast information guide, the image screen corresponding to the broadcast channel which is under reproduction.

The control method may further comprise: determining whether channel broadcast information request is input from the outside; and if the channel broadcast information request has been input, displaying broadcast information of a plurality of channels corresponding to a current day, on a portion of the display unit.

The broadcast information of the plurality of channels may comprise broadcast program title information among broadcast program information of the plurality of channels corresponding to the current day, and the displaying the broadcast information of the plurality of channels comprises enumerating and indicating the broadcast program title information of the plurality of channels corresponding to the current day according to each channel and according to the broadcast time table when the channel broadcast information request has been input.

The displaying the broadcast information of the plurality of channels may comprise displaying a channel broadcast information guide including the broadcast information of the plurality of channels corresponding to the current day on a portion of the display unit.

The control method may further comprise: determining whether channel broadcast information request is input from the outside; and if the channel broadcast information request has been input, displaying broadcast information of a plurality of channels corresponding to a current day, on a portion of the display unit.

The broadcast information of the plurality of channels may comprise broadcast program title information among broadcast program information of the plurality of channels corresponding to the current day, and the displaying the broadcast information of the plurality of channels may comprise enumerating and indicating the broadcast program title information of the plurality of channels corresponding to the current day according to each channel and according to the broadcast time table when the channel broadcast information request has been input.

The displaying the broadcast information of the plurality of channels may comprise displaying a channel broadcast information guide including the broadcast information of the plurality of channels corresponding to the current day on a portion of the display unit.

According to another aspect of the present invention, there is provided an image processing apparatus including a user input portion and a display unit displaying images according to received broadcast signals, the image processing apparatus comprising: a broadcast signal processor which processes the broadcast signals to be displayed on the display unit; a user interface (UI) generating unit which generates a weekly broadcast information guide comprising individual day broadcast information of a plurality of days which enumerates the individual day broadcast information of the a plurality of days corresponding to a predetermined broadcast channel according to each individual day and a broadcast time table on a portion of the display unit; and a controller which controls the broadcast signal processor to display the received broadcast signal, and controls the UI generating unit to display the weekly broadcast information guide on the display unit when the individual day broadcast information is requested through manipulation of the user input portion.

The individual day broadcast information of the plurality of days may comprise broadcast program title information among the individual day broadcast program information of the plurality of days corresponding to the predetermined broadcast channel.

### BRIEF DESCRIPTION OF THE DRAWINGS

The above and/or other aspects of the present invention will become apparent and more readily appreciated from the following description of the exemplary embodiments, taken in conjunction with the accompanying drawings of which:

FIG. 1 is a view of a broadcast information guide in a conventional image processing apparatus;

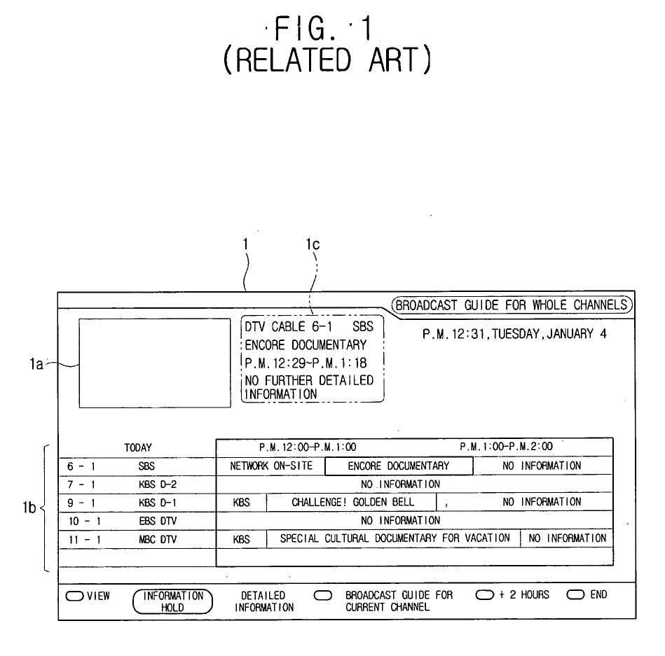

FIG. 2 is a block diagram of an image processing apparatus according to an exemplary embodiment of the present invention;

FIG. 3 is a view of a weekly broadcast information guide in the image processing apparatus according to an exemplary embodiment of the present invention;

FIG. 4A is a view of a channel being changed into another channel in the weekly broadcast information guide of FIG. 3;

FIG. 4B is a view of detailed broadcast program information on program W-l′ of the weekly broadcast information guide of FIG. 4A;

FIG. 5 is a view of a channel broadcast information guide in the image processing apparatus according to an exemplary embodiment of the present invention;

FIG. 6 is a flowchart of a method of controlling a weekly broadcast information guide in an image processing apparatus according to an exemplary embodiment of the present invention; and

FIG. 7 is a flowchart view for explaining a control flow controlling a channel broadcast information guide in an image processing apparatus according to an exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to like elements throughout.

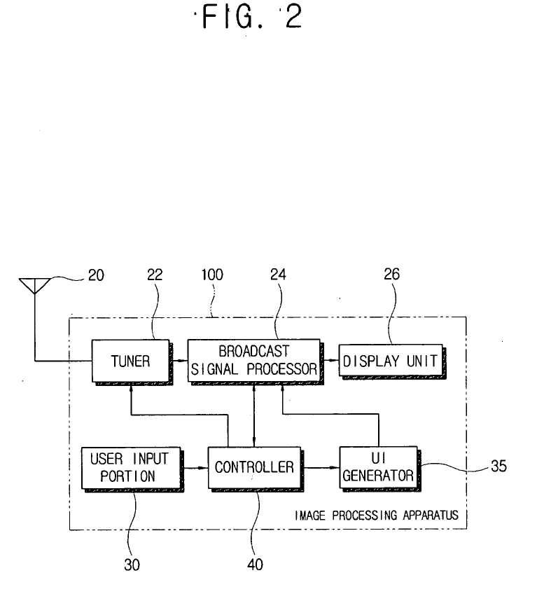

Referring to FIG. 2, an image processing apparatus 100 includes an antenna 20, a tuner 22, a broadcast signal processor 24, a display unit 26, a user interface (UI) generating unit 35, a user input portion 30 and a controller 40. The image processing apparatus 100 is an apparatus, such as a set-top box, a digital television, etc., which receives and uses EPG information. A digital television which receives and processes digital broadcast signals will be described as an exemplary embodiment of the image processing apparatus of FIG. 2 according to the present invention.

The antenna 20, which is a functional unit for receiving broadcast signals, receives digital broadcast signals.

The tuner 22 receives the digital broadcast signal received via the antenna 20 under the control of the controller 40, and plays a role of selecting a broadcast signal of a broadcast channel shifted via the user input portion 30.

The broadcast signal processor 24 processes the selected broadcast signal which is output from the tuner 22 in order to be reproduced on the display unit 26. The broadcast signal processor 24 may include a channel decoder (not shown) which demodulates an Intermediate Frequency (IF) broadcast signal of the digital broadcast signal selected by the tuner 22 into a predetermined transport stream and outputs the demodulated result, a TP decoder (not shown) which decodes program information and a predetermined video signal sequence of the corresponding channel shifted by a user from the predetermined transport stream output from the channel decoder and outputs the decoded result, and a video decoder which receives the video signal sequence output from the TP decoder, decompresses the compressed signal, restores the decompressed signal into an original video signal, and outputs the restored original video signal.

Moreover, the broadcast signal processor 24 processes an EPG screen of an EPG screen signal output from the UI generating unit 35 to be displayed on the display unit 26. The broadcast signal processor 24 may process a video signal corresponding to an image screen according to a broadcast signal output from the tuner 22 and the EPG screen signal in a picture-in-picture (PIP) form so that the image screen can be overlapped over a portion of the EPG screen, to then be displayed on the display unit 26.

Various kinds of additional data extracted from a predetermined transport stream output from the channel decoder (not shown) of the broadcast signal processor 24 are stored in a predetermined memory for each data under the control of the controller 40 to be described later. Also, data to be displayed among the additional data is processed through the UI generating unit 35 under the controller 40 and can be displayed on the display unit 26 by the broadcast signal processor 24. The additional data includes EPG information including various kinds of information such as broadcast channel information and broadcast program information.

The display unit 26 receives a video signal from the broadcast signal processor 24 and displays an image screen. The display unit 26 includes a display panel on which the video signal is displayed and a panel driving portion which processes the video signal input from the broadcast signal processor 24 to display the video signal on the display panel.

The user input portion 30 outputs a key signal to the controller 40 according to manipulation of a user. The user input portion 30 may include a first EPG key for requesting for individual day broadcast information, a second EPG key for requesting for channel broadcast information, up/down and left/right keys for navigation, a predetermined selection key, an information key and an EXIT key. Further, the user input portion 30 comprises a key signal generator which generates a key signal corresponding to manipulation(s) of each key.

The user input portion 30 may be externally provided on the image processing apparatus 100. Otherwise, the user input portion 30 may be provided as an independently connected input unit such as a mouse and a keyboard, or may be provided as a wireless remote controller. Here, if a user manipulates the keys, the key signal generator unit generates a key signal corresponding to a key stroke and then supplies it to the controller 40. Accordingly, the controller 40 controls the broadcast signal processor 24, the UI generating unit 35, the tuner 22, etc. corresponding to the key signal input from the key signal generator.

The UI generating unit 35 generates an EPG screen signal which displays the weekly broadcast information guide or the channel broadcast information guide under the control of the controller 40 based on EPG information of the additional data which is extracted from the broadcast signal processor 24. Likewise, the EPG screen signal which is generated from the UI generating unit 35 is combined with the video signal output from the broadcast signal processor 24 to then be displayed on the display unit 26.

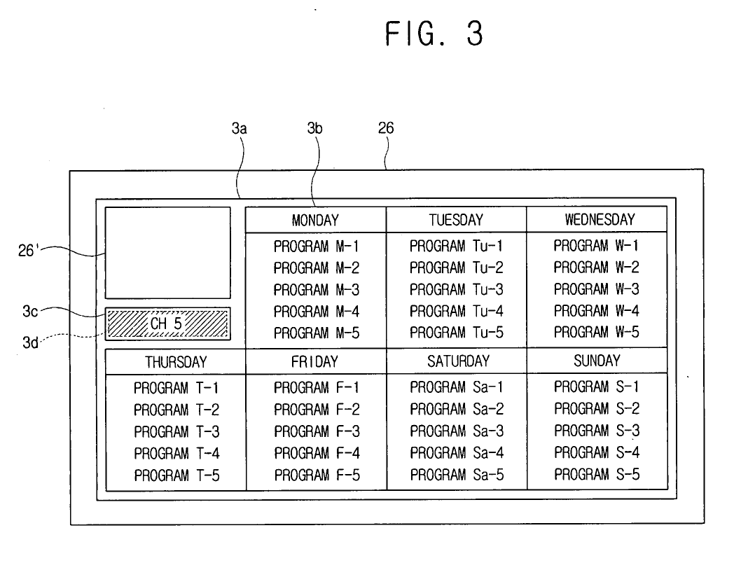

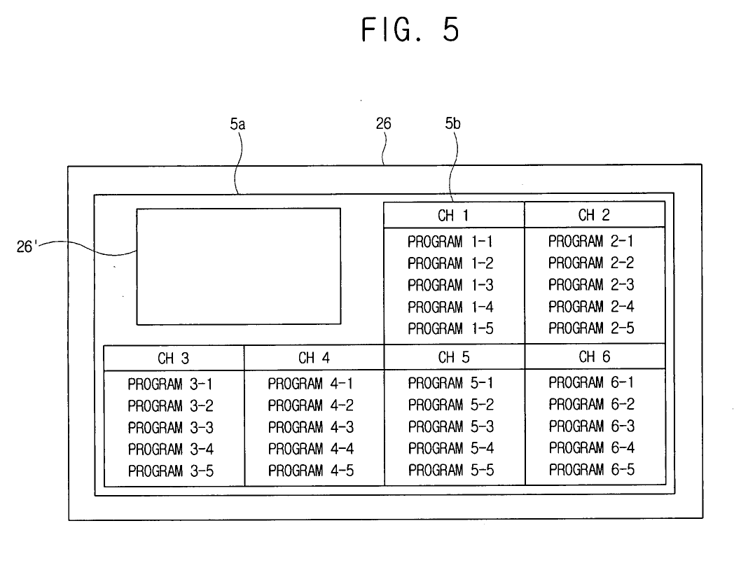

Here, as shown in FIGS. 3 and 5, the UI generating unit 35 generates the EPG screen signal for displaying either a weekly broadcast information guide 3a or a channel broadcast information guide 5a considering only broadcast program title information under the control of the controller 40. The weekly broadcast information guide 3a and the channel broadcast information guide 5a will be described in more detail later.

In order to display an image based on the received broadcast signals on the display unit 26, the controller 40 controls the broadcast signal processor 24, and the various kinds of additional data which are extracted from a predetermined transport stream output from the channel decoder (not shown) in the broadcast signal processor 24 are stored in a predetermined memory for each data.

If the first EPG key of the user input portion 30 is manipulated to request for the individual day broadcast information, the controller 40 extracts the weekly broadcast program title information from the prestored EPG information and controls the UI generating unit 35 to display the EPG screen which is the weekly broadcast information guide 3a of FIG. 3 on the display unit 26. The controller 40 controls the UI generating unit 35 in order to control the function of the weekly broadcast information guide 3a according to manipulation of the up/down keys and the left/right keys for navigation, a predetermined selection key, the information key and/or the EXIT key of the user input portion 30.

Moreover, if the second EPG key of the user input portion 30 is manipulated to request the channel broadcast information, the controller 40 controls the UI generating unit 35 to extract the channel broadcast program title information from the prestored EPG information to then display the EPG screen which is the channel broadcast information guide 5a of FIG. 5 on the display unit 26. The controller 40 controls the UI generating unit 35 in order to control the function of the channel broadcast information guide 5a according to manipulation of the up/down key and the left/right key for navigation, the predetermined selection key, the information key and/or the EXIT key of the user input portion 30.

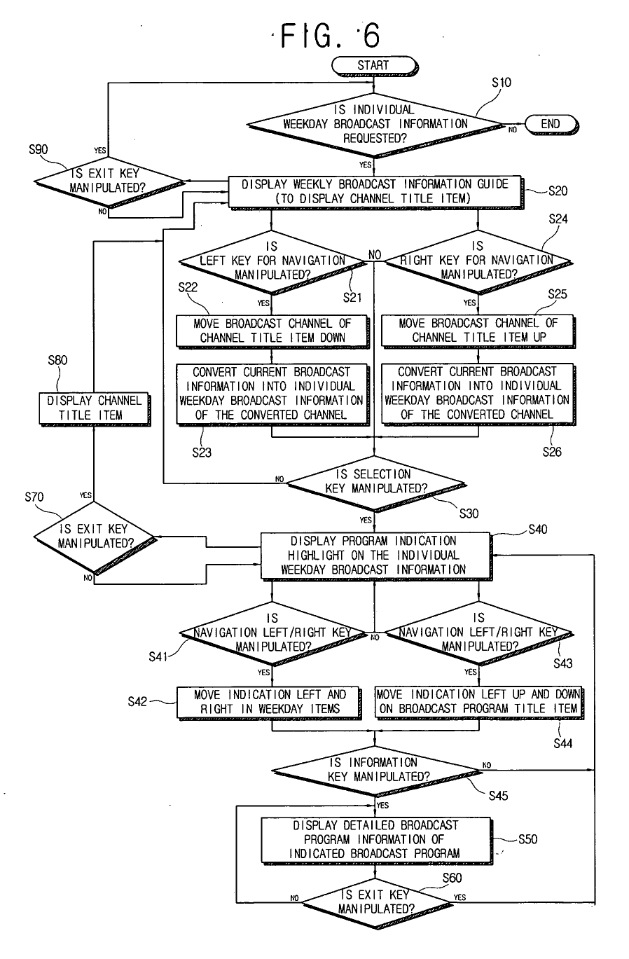

Referring to FIG. 6, a method of controlling a weekly broadcast information guide in an image processing apparatus 100 such as a digital television will be described below.

The controller 40 controls the tuner 22 and the broadcast signal processor 24 to receive a broadcast signal corresponding to a broadcast channel selected through the user input portion 30 and process the received broadcast signal to then be displayed as an image on the display unit 26. The controller 40 determines whether the individual day broadcast information is requested (i.e., the first EPG key input is present) through the user input portion 30 (S10). In the case that the individual day broadcast information is requested, the controller 40 controls the UI generating unit 35 to display the EPG screen which is the weekly broadcast information guide 3a of FIG. 3 based on the prestored EPG information on the display unit 26 (S20). Referring to FIG. 3, the weekly broadcast information guide 3a initially displayed by the first EPG key input will be described in detail.

As shown in FIG. 3, the weekly broadcast information guide 3a displayed on the display unit 26 includes individual day broadcast information 3b for one week, a channel identifier item 3c and a sub-image screen 26′.

The sub-image screen 26′ is an image screen corresponding to the broadcast channel (for example, CH 5) which is displayed or reproduced on the display unit 26 before displaying the weekly broadcast information guide 3a. That is, the sub-image screen 26′ obtained by reducing the size of the image screen which is being reproduced before indication of the weekly broadcast information guide 3a is selected is displayed on a portion of the display unit 26 in the weekly broadcast information guide 3a. Accordingly, the broadcast of the corresponding broadcast channel (CH 5) can be continuously watched.

The sub-image screen 26′ can be generated by the broadcast signal processor 24 which processes the EPG screen signal corresponding to the individual day broadcast information 3b and the channel identifier item 3c which are generated from the UI generating unit 35 and the video signal which is obtained by processing the broadcast signal of the broadcast channel (CH 5) which is being reproduced in a PIP form, and displays the weekly broadcast information guide 3a on the display unit 26. The weekly broadcast information guide 3a may be designed so that the sub-image screen 26′ is not displayed in the weekly broadcast information guide 3a, but a large amount of the individual day broadcast information 3b of a week is displayed.

The individual day broadcast information 3b for a week is the individual day broadcast information of each day from Monday to Sunday corresponding to a predetermined broadcast channel, and is displayed as the EPG screen signal generated in the UI generating unit 35 on a portion of the weekly broadcast information guide 3a. FIG. 3 shows the weekly broadcast information guide 3a initially displayed by the first EPG key input. Therefore, the individual day broadcast information from Monday to Sunday corresponding to the broadcast channel (CH 5) which is being reproduced is indicated on the individual day broadcast information 3b for a week. The broadcast information indicated on the individual day broadcast information 3b for a week enumerates only the broadcast program title information among broadcast program information corresponding to each day according to the broadcast time table. For example, in the case of the broadcast information of Wednesday, only the broadcast program title information of the broadcast programs broadcasted on Wednesday via the broadcast channel CH 5 according to the broadcast time table is enumerated and represented a Program W-1, Program W-2, Program W-3, Program W-4, Program W-5, etc.

The channel identifier item 3c shows the broadcast channel corresponding to the individual day broadcast information 3b for an indicated week and indicated with the EPG screen signal generated in the UI generating unit 35. That is, FIG. 3 shows the weekly broadcast information guide 3a initially indicated by the first EPG key input. Therefore, a channel number “CH 5” is indicated on the channel identifier item 3c.

Thus, while a user views the weekly broadcast information guide 3a which briefly provides only the broadcast program titles, the user can conveniently and rapidly grasp what broadcast programs are going to be broadcasted for a week via the broadcast channel CH 5.

Here, it may be preferable that when the weekly broadcast information guide 3a is displayed in an initial state by the first EPG key input, the UI generating unit 35 displays the channel identifier item 3c as a predetermined indication highlight 3d, as shown in FIG. 3.

Here, if it is determined that the EXIT key is input through the user input portion 30 (S90), the controller 40 controls the tuner 22, the broadcast signal processor 24, and the UI generating unit 35 to stop displaying the weekly broadcast information guide 3a and to display the image screen of the broadcast channel (CH 5) which has been being reproduced on the display unit 26.

Here, in the case that a user tries to examine the broadcast information of the other broadcast channel, the controller 40 determines whether the left key for navigation in the user input portion 30 is manipulated (S21), in the state where the channel identifier item 3c has been indicated as the predetermined indication highlight 3d in operation S20. If the navigation left key is manipulated, the controller 40 controls the UI generating unit 35 to change the broadcast channel of the channel identifier item 3c (S22) to a lower channel. Moreover, the controller 40 controls the UI generating unit 35 to convert the individual day broadcast information 3b for a week into the individual day broadcast information for the week corresponding to the lower broadcast channel (for example : CH 4) of the channel identifier item 3c, and then display the converted result, based on the prestored EPG information (S23).

Moreover, the controller 40 determines whether the right key for navigation in the user input portion 30 is manipulated (S24) in the state that the channel identifier item 3chas been indicated with a predetermined indication highlight 3d in operation S20. If the navigation right key is manipulated, the controller 40 controls the UI generating unit 35 to change the broadcast channel of the channel identifier item (3c) to an upper channel (S25). Moreover, the controller 40 controls the UI generating unit 35 to convert the individual day broadcast information 3b for a week into the individual day broadcast information for the week corresponding to the upper broadcast channel (for example : CH 6) of the channel identifier item 3c and then display the converted result, based on the prestored EPG information (S26).

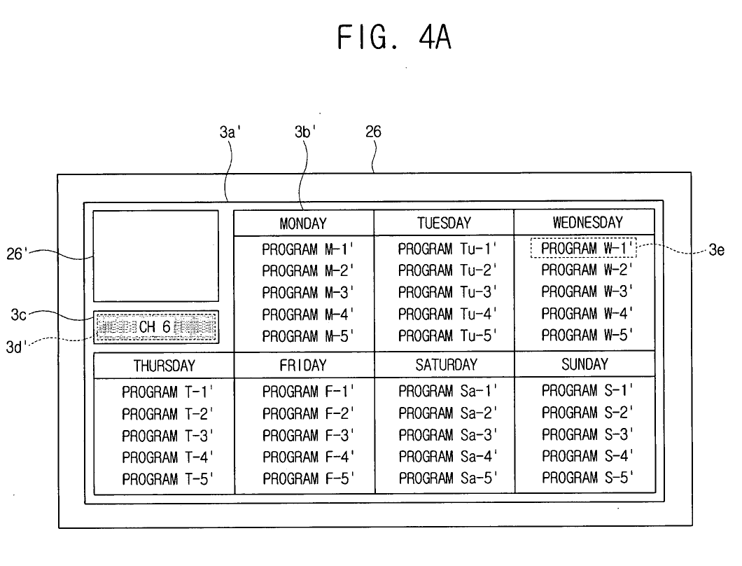

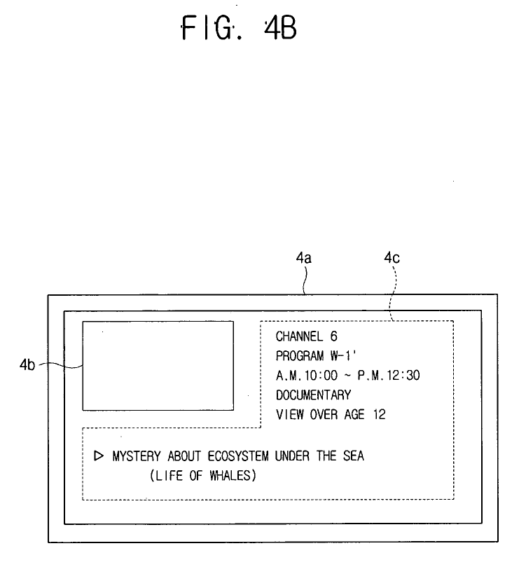

Here, referring to FIG. 4A, a process of changing the broadcast channel with the navigation right key will be described in the process of converting the broadcast channel with the navigation left/right key, in the state where the channel identifier item 3c has been indicated with a predetermined indication highlight 3d.

If the navigation right key of the user input portion 30 is manipulated, in the state where the weekly broadcast information guide 3a has been displayed on the display unit 26, the weekly broadcast information guide 3a of FIG. 3 is converted into the weekly broadcast information guide 3a′ of FIG. 4A, and then the converted result is displayed. That is, the channel number CH 5 of the channel identifier item 3c in the weekly broadcast information guide 3a is changed to the channel number CH 6 and the up-converted result is displayed as in the weekly broadcast information guide 3a′ of FIG. 4A. Moreover, the individual day broadcast information 3b for a week corresponding to the broadcast channel CH 5 as shown in FIG. 3 is converted to the individual day broadcast information 3b′ for the week corresponding to the broadcast channel CH 6 as shown in FIG. 4A and then the converted result is displayed.

Here, it may be preferable that the sub-image screen 26′ continuously displays the image screen of the broadcast channel CH 5 which is the reproduced just before displaying the weekly broadcast information guide 3a regardless of the shift of the broadcast channel indicated on the channel identifier item 3c.

Thus, while viewing the weekly broadcast information guide displayed on the display unit 26, a user converts the broadcast channel up and down. Accordingly, the user can conveniently grasp what broadcast programs are going to be broadcasted for a week via various broadcast channels.

Thereafter, the controller 40 determines whether the predetermined selection key is manipulated through the user input portion 30 (S30). Here, it may be preferable that the selection key is an input key for selecting the broadcast channel indicated on the channel identifier item 3c. If the selection key is manipulated, the controller 40 controls the UI generating unit 35 in order not to indicate the indication highlight 3d indicating the channel identifier item 3c or change the indication highlight 3d′ as shown in FIG. 4A. This is to indicate that the selection key has been manipulated and the broadcast channel CH 6 indicated on the channel identifier item 3c has been selected. Moreover, the controller 40 controls the UI generating unit 35 (S40), in order to indicate the program indication highlight 3e on the individual day broadcast information 3b′ for a week if the selection key has been manipulated. Here, it may be preferable that when the UI generating unit 35 indicates the program indication highlight 3e, it indicates the broadcast program title item (Wednesday, Program W-1′) corresponding to the broadcast program title information according to the current broadcast time table.

The controller 40 determines whether the navigation left/right key is manipulated (S41), in the state of having indicated the program indication highlight 3e. The controller 40 controls the UI generating unit 35 (S42) to make the program indication highlight 3emove to the left/right in consideration of the day item when the navigation left/right key has been manipulated. For example, if the navigation left key is manipulated in the weekly broadcast information guide 3a′ of the state that is illustrated in FIG. 4A, the program indication highlight 3e indicating the program W-1′ of Wednesday moves to the left side in order to indicate the program Tu-1′ of Tuesday. Similarly, if the navigation right key is manipulated, the program indication highlight 3e indicating the program W-1′ of Wednesday moves to the right side, in order to indicate the program T-1′ of Thursday.

The controller 40 determines whether the navigation up/down key is manipulated (S42), in the state of having indicated the program indication highlight 3e in operation S40. If the navigation up/down key is manipulated, the controller 40 controls the UI generating unit 35 in order to make the program indication highlight 3e move up and down in consideration of the broadcast program title item (S44). For example, if the navigation down key is manipulated in the weekly broadcast information guide 3a′ of the state that is illustrated in FIG. 4A, the program indication highlight 3e indicating the program W-1′ of Wednesday moves to the lower side, to thus indicate the program W-2′ of the same day. Similarly, if the navigation up key is manipulated, the program indication highlight 3eindicating the program W-1′ of Wednesday moves to the upper side. Here, in the case that the program W-1′ indicated among the broadcast program title items indicated is positioned at the upper-most position as in the weekly broadcast information guide 3a′ of FIG. 4A, the program indication highlight 3e will not move although the navigation up key is manipulated if the broadcast program of the previous broadcast time table does not exist. Here, when the navigation up key has been manipulated, the broadcast program title items corresponding to Wednesday move down one step by one step to thus make the program indication highlight 3e indicate the program W-0′ if the broadcast program (for example Program W-0′) of the previous broadcast time table which has not been indicated exists.

Here, if it is determined that the EXIT key is manipulated through the user input portion 30 (S70), the controller 40 controls the UI generating unit 35 (S80) to stop displaying the program indication highlight 3e but to display the channel identifier item 3cwith the indication highlight 3d, to then enters operation S20.

Thereafter, the controller 40 determines whether a predetermined information key is manipulated through the user input portion 30 (S45), in the state where the program indication highlight 3e has been displayed. If the information key is manipulated, the controller 40 controls the UI generating unit 35 to display the detailed broadcast program information of the broadcast program corresponding to the broadcast program title item which is indicated by the program indication highlight 3e (S50).

The detailed broadcast program information 4a displayed in the case that the information key has been manipulated will be described with reference to FIG. 4B, in the state where the program indication highlight 3e has displayed the program W-l′ in the weekly broadcast information guide 3a′ as shown in FIG. 4A.

The detailed broadcast program information 4a as illustrated in FIG. 4B may include detailed broadcast information 4c corresponding to the program W-1′ which the program indication highlight 3e indicates and a thumbnail image 4b showing the program W-1′. The detailed broadcast information 4c may include any one among broadcast channel information (for example, CH 6), title information (Program W-1′) of the indicated broadcast program, broadcast time table information (a.m. 10:00 to p.m. 12:30), view age limit information (viewable over age 12), broadcast genre information (documentary), broadcast content information (mystery about ecosystem under the sea) and character information (life of the whale). The thumbnail image 4b may not be displayed.

The controller 40 can control the UI generating unit 35 to display the detailed broadcast program information 4a on the display unit 26 in a pop-up form in the case that the information key has been manipulated, to thus cover a portion of the weekly broadcast information guide 3a′ or display only the detailed broadcast program information 4a without displaying the weekly broadcast information guide 3a′ temporarily.

Thus, the user can obtain the detailed broadcast program information which the user cannot grasp from the weekly broadcast information guide which briefly provides only the title information of the broadcast program.

If it is determined that the EXIT key is manipulated through the user input portion 30 in operation S60, the controller 40 returns to operation S40 to stop displaying the detailed broadcast program information 4a and display the weekly broadcast information guide 3a′.

As described above, the image processing apparatus and the control method of controlling the same according to the present invention display the weekly broadcast information guide which briefly provides only the individual day broadcast program title for a week corresponding to the single broadcast channel, so that users can conveniently and rapidly grasp what broadcast programs are going to be broadcasted for a week in the corresponding broadcast channel. Further, it is possible to change the broadcast channel while viewing the weekly broadcast information guide, so that the users can conveniently grasp what broadcast programs are going to be broadcasted in various kinds of broadcast channels.

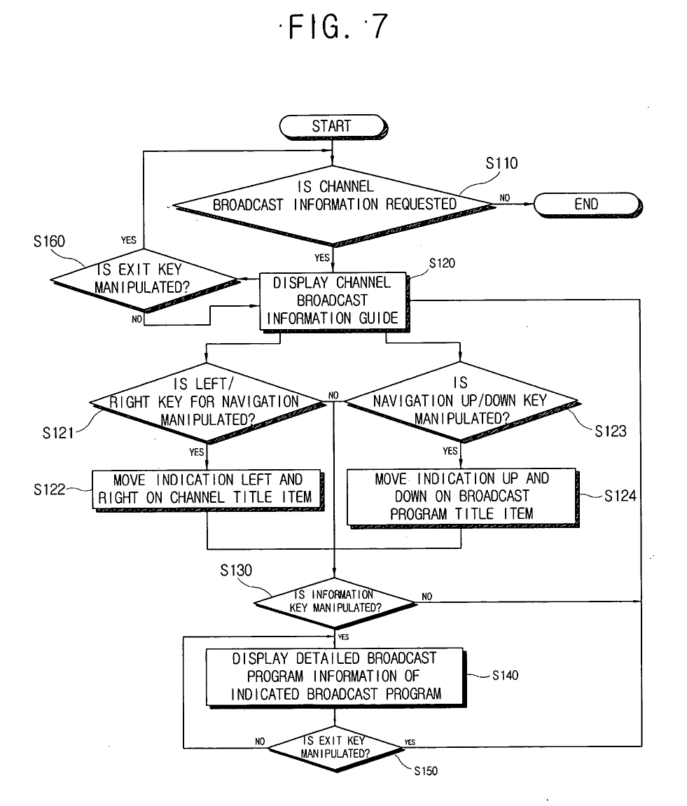

Hereinbelow, referring to FIG. 7, a control method of controlling a channel broadcast information guide in an image processing apparatus 100 such as a digital television will be described.

The controller 40 controls the tuner 22 and the broadcast signal processor 24 to receive a broadcast signal corresponding to a broadcast channel selected through the user input portion 30 and processes the received broadcast signal to be displayed on the display unit 26. The controller 40 determines whether the channel broadcast information is requested (whether a second EPG key input is received) through the user input portion 30 (S110). In the case that the channel broadcast information is requested, the controller 40 controls the UI generating unit 35, in order to display an EPG screen which is a channel broadcast information guide 5a of FIG. 5 based on the prestored EPG information on the display unit 26 (S120). Referring to FIG. 5, the displayed channel broadcast information guide 5a will be described which is initially displayed by the second EPG key input of operation S120.

As shown in FIG. 5, the channel broadcast information guide (5a) displayed on the display unit 26 includes broadcast information 5b of a plurality of channels and a sub-image screen 26′ corresponding to the current day.

The sub-image screen 26′ is an image screen corresponding to the broadcast channel (for example, CH 5) which is reproduced on the display unit 26 before displaying the channel broadcast information guide 5a. That is, the sub-image screen 26′ which is obtained by reducing the size of the image screen which is reproduced before the display of the channel broadcast information guide 5a is selected is displayed on a portion of the channel broadcast information guide 5a. Accordingly, the broadcast of the corresponding broadcast channel (CH 5) can be continuously viewed.

The broadcast information 5b of a plurality of channels corresponds to the current day is displayed by the EPG screen signal generated in the UI generating unit 35 on a portion of the channel broadcast information guide 5a. Here, as shown in FIG. 5, a plurality of channels of the broadcast information 5b are enumerated by only the broadcast program title information according to the broadcast time table among the broadcast program information corresponding to each broadcast channel. For example, in the case of the broadcast information of the broadcast channel CH 6, only the broadcast program title information of the broadcast programs which are today broadcast via the broadcast channel CH 6 according to the broadcast time table are enumerated as Program 6-1, Program 6-2, Program 6-3, Program 6-4, Program 6-5, etc. to then be displayed.

It may be preferable that since FIG. 5 shows the weekly broadcast information guide 5a initially displayed by the second EPG key input, the broadcast program title item (for example : CH 5, and Program 5-4) corresponding to the broadcast program title information according to the current broadcast time table via the broadcast channel CH 5 which is being reproduced is indicated with the indication highlight 5c.

Thus, while a user views the channel broadcast information guide 5a which briefly provides only the broadcast program title, the user can conveniently and rapidly grasp what broadcast programs which are today going to be broadcasted by each broadcast channel.

If it is determined that the EXIT key is manipulated through the user input portion 30 in operation S160, the controller 40 controls the tuner 22, the broadcast signal processor 24, and the UI generating unit 35 to stop displaying the channel broadcast information guide 5a and display the image screen of the broadcast channel (CH 5) which is reproduced on the display unit 26.

The controller 40 determines whether the navigation left/right key is manipulated (S121). If the navigation left/right key is manipulated, the controller 40 controls the UI generating unit 35 in order to make the indication highlight 5c move to the left/right in consideration of the channel item (S122). For example, if the navigation left key is manipulated in the channel broadcast information guide 5a of the state that is illustrated in FIG. 5, the indication highlight 5c indicating the program 5-4 of the channel number CH 5 moves to the left side, to thus indicate the program 4-4 of the channel number CH 4. Similarly, if the navigation right key is manipulated, the indication highlight 5c indicating the program 5-4 of the channel number CH 5 moves to the right side, to thus indicate the program 6-4 of the channel number CH 6.

The controller 40 determines whether the navigation up/down key is manipulated (S123). If the navigation up/down key is manipulated, the controller 40 controls the UI generating unit 35 to make the indication highlight 5c move in the up/down direction in consideration of the broadcast program title item (S124). For example, if the navigation down key is manipulated in the channel broadcast information guide 5a of the state that is illustrated in FIG. 5, the indication highlight 5c indicating the program 5-4 of the channel number CH 5 moves down, to thus indicate the program 5-5 of the same channel. Similarly, if the navigation up key is manipulated, the indication highlight 5c indicating the program 5-4 of the channel number CH 5 moves up, to thus indicate the program 5-3 of the same channel.

Thereafter, the controller 40 determines whether the predetermined information key is manipulated through the user input portion 30 (S130). If the information key is manipulated, the controller 40 controls the UI generating unit 35 to display the detailed broadcast program information of the broadcast program corresponding to the broadcast program title item which the indication highlight 5c indicates (S140). Here, since the displayed detailed broadcast program information can be displayed in the same manner as that of the above-described detailed broadcast program information 4a of FIG. 4B, the detailed description thereof will be omitted.

Thus, a user can obtain the detailed information of the broadcast program which the user cannot grasp from the channel broadcast information guide which briefly provides only the title information of the broadcast program.

If it is determined (S150) that the EXIT key is manipulated through the user input portion 30, the controller 40 does not display the detailed broadcast program information but returns to operation SI 20 for displaying the channel broadcast information guide 5a.

As described above, the image processing apparatus and the control method of controlling the same according to the present invention indicates the channel broadcast information guide which briefly provides only a plurality of channels of broadcast program titles corresponding to a single day (for example, the current day). As a result, users can conveniently and rapidly grasp what broadcast programs are going to be broadcasted for today according to each channel.

As described above, the present invention provides an image processing apparatus and a control method of controlling the same, which provides a weekly broadcast information guide which briefly provides only broadcast program titles, and thus enables users to conveniently and rapidly grasp what broadcast programs are going to be broadcasted for a week via a predetermined broadcast channel.

Moreover, the present invention provides an image processing apparatus and a control method of controlling the same, which provides a channel broadcast information guide which briefly provides only broadcast program titles, and thus enable users to conveniently and rapidly grasp what broadcast programs are going to be broadcasted for a single day via each broadcast channel.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A method of controlling an image processing apparatus comprising a display unit which displays images based on received broadcast signals, the control method comprising:
storing data of a broadcast signal; and
displaying on a portion of the display unit individual day broadcast information corresponding to a broadcast channel for a plurality of days based on the stored data if the individual day broadcast information is requested.

2. The method of claim 1, wherein the individual day broadcast information comprises broadcast program title information.

3. The method of claim 2, wherein the displaying the individual day broadcast information corresponding to the broadcast channel for the plurality of days comprises enumerating and displaying the individual day broadcast program title information corresponding to the broadcast channel for the plurality of days according to a broadcast time table of each of the plurality of days.

4. The method of claim 3, wherein the broadcast channel is a broadcast channel to be reproduced.

5. The method of claim 4, wherein the displaying the individual day broadcast information corresponding to the broadcast channel for the plurality of days further comprises displaying a weekly broadcast information guide including the individual day broadcast information corresponding to the broadcast channel for one week.

6. The method of claim 5, wherein the displaying the weekly broadcast information guide further comprises displaying a channel identifier item showing the broadcast channel on the weekly broadcast information guide.

7. The method of claim 6, wherein the displaying the weekly broadcast information guide further comprises displaying the weekly broadcast information guide in a state of indicating the channel identifier item by using a predetermined indication highlight.

8. The method of claim 7, further comprising, if a left or right shift for converting the channel identifier is input in a state where the channel identifier item is indicated, converting a current broadcast channel into the broadcast channel of the channel identifier item according to the input left or right shift.

9. The method of claim 8, further comprising converting the individual day broadcast information for the one week displayed on the weekly broadcast information guide into the individual day broadcast information corresponding to the broadcast channel of the channel identifier item for the one week.

10. The method of claim 9, further comprising if a predetermined input is input in a state where the channel identifier item is directed, displaying a program indication highlight indicating broadcast information corresponding to a current broadcast time among the individual day broadcast information for the one week.

11. The method of claim 10, further comprising if the left or right shift is input in the state where the program indication highlight has been indicated, moving the program indication highlight in the left or right direction on day items of the individual day broadcast information for the one week according to the input left or right shift.

12. The method of claim 11, further comprising if an up or down shift is input in the state where the program indication highlight has been indicated, moving the program indication highlight in an up or down direction on broadcast program title items of the individual day broadcast information for the one week according to the input up or down shift.

13. The method of claim 12, further comprising if a detailed information request is input in the state where the channel indication highlight has been indicated, displaying detailed broadcast program information of the broadcast programs directed by the program indication highlight on the individual day broadcast information for the one week.

14. The method of claim 13, wherein the detailed broadcast program information comprises at least one of title information, broadcast time information, view age limit information, broadcast genre information, broadcast content information, and character information of the indicated broadcast program.

15. The method of claim 14, wherein the displaying the weekly broadcast information guide comprises further displaying an image screen on a portion of the weekly broadcast information guide, the image screen corresponding to the broadcast channel which is reproduced.

16. The method of claim 1, further comprising if a channel broadcast information request is received, displaying broadcast information corresponding to a plurality of channels for a current day, on a portion of the display unit

17. The method of claim 16, wherein the broadcast information of the plurality of channels comprises broadcast program title information among broadcast program information corresponding to the plurality of channels for the current day, and the displaying the broadcast information corresponding to the plurality of channels comprises enumerating and indicating the broadcast program title information corresponding to the plurality of channels for the current day according to each channel and according to the broadcast time table.

18. The method of claim 17, wherein the displaying the broadcast information corresponding to the plurality of channels further comprises displaying a channel broadcast information guide including the broadcast information corresponding to the plurality of channels for the current day on a portion of the display unit.

19. The method of claim 15, further comprising if the channel broadcast information request is received, displaying broadcast information corresponding to a plurality of channels for a current day, on a portion of the display unit

20. The method of claim 19, wherein the broadcast information of the plurality of channels comprises broadcast program title information among broadcast program information corresponding to the plurality of channels for the current day, and the displaying the broadcast information corresponding to the plurality of channels comprises enumerating and indicating the broadcast program title information corresponding to the plurality of channels for the current day according to each channel and according to the broadcast time table.

21. The method of claim 20, wherein the displaying the broadcast information corresponding to the plurality of channels comprises displaying a channel broadcast information guide including the broadcast information corresponding to the plurality of channels for the current day on a portion of the display unit.

22. An image processing apparatus comprising:
a user input unit;
a display unit which displays images according to received broadcast signals;
a broadcast signal processor which processes the broadcast signals to be displayed on the display unit;
a user interface generating unit which generates a weekly broadcast information guide comprising individual day broadcast information for a plurality of days which enumerates the individual day broadcast information corresponding to a broadcast channel for the a plurality of days according to each individual day and a broadcast time table on a portion of the display unit; and
a controller which controls the broadcast signal processor to display the received broadcast signal, and controls the user interface generating unit to display the weekly broadcast information guide on the display unit if the individual day broadcast information is requested through the user input unit.

23. The image processing apparatus of claim 22, wherein the individual day broadcast information corresponding to the broadcast channel for the plurality of days comprises broadcast program title information among the individual day broadcast program information of the plurality of days corresponding to the predetermined broadcast channel.
